(19) United States
(12) Patent Application Publication
(10) Pub. No.: US 2010/0218495 A1
(43) Pub. Date: Sep. 2, 2010

(54) SYSTEMS AND DEVICES FOR STORING ENERGY IN AN ELASTIC ROPE SPRING MOTOR

(75) Inventor: Frederick K. Cowan, Tucson, AZ (US)

Correspondence Address: Ingrassia Fisher & Lorenz, P.C. (Raytheon), 7010 East Cochise Road, Scottsdale, AZ, 85253-1406, US

(73) Assignee: RAYTHEON COMPANY, Waltham, MA (US)

(21) Appl. No.: 12/394,321

(22) Filed: Feb. 27, 2009

(51) Int. Cl. F03G 7/00; F16F 1/00

(52) U.S. Cl. 60/516; 267/69

(57) ABSTRACT

Systems and devices for storing mechanical energy in a spring motor or the like are described. In one implementation, an energy storage device includes an elastic rope, a spool and a control mechanism. The elastic rope is reversibly deformable from a relaxed state to a stretched state for storing mechanical energy. The spool is coupled to the elastic rope, and is configured to maintain the elastic rope in the stretched state while the elastic rope is wound around the spool. The control mechanism is coupled to the spool and is configured to allow the spool to rotate in response to the elastic rope relaxing from the stretched state to the relaxed state for retrieval of stored mechanical energy. In some implementations, the elastic rope may be formed from an elastomer wrapped with a fiber made from carbon nanotubes or other synthetic strengthening material.

### TECHNICAL FIELD

The following discussion generally relates to mechanical energy storage systems and devices, and in particular relates to systems, devices and techniques for storing energy in an elastic rope.

### BACKGROUND

Many different types of energy storage devices have been developed to store energy in forms that can be drawn upon at a later time to perform useful functions. A conventional battery, for example, stores readily-convertible chemical energy for subsequent retrieval of electrical power. Mechanical energy storage systems have similarly been used to store potential energy for subsequent retrieval as kinetic energy that can be mechanically coupled to drive a particular load. A wind up clock, for example, stores potential energy in mechanical spring tension that can be harnessed over time to drive the hands of the clock. Other types of mechanical energy storage devices and systems include flywheels, spring motors and the like. Many different types of energy storage devices and systems are commonly used in various applications, including any number of aerospace, defense, industrial, transportation and other settings.

Generally speaking, it is desirable to design mechanical and other energy storage systems with a relatively high energy density. That is, such systems are typically intended to store as much energy as possible for a given mass or volume. In aerospace and other vehicular applications, in particular, it is highly desirable to store relatively large amounts of energy in a relatively compact space, and with a relatively low mass.

It is therefore desirable to create energy storage devices and systems with relatively high energy densities. Such devices and systems may ideally be relatively lightweight, rechargeable and/or otherwise suited for vehicle propulsion or other purposes. These and other desirable features and characteristics will become apparent from the subsequent detailed description and the appended claims, taken in conjunction with the accompanying drawings and this background section.

### BRIEF DESCRIPTION

Various systems, devices and methods for storing mechanical energy are described below. In one implementation, an energy storage device suitably comprises an elastic rope, a spool and a control mechanism. The elastic rope is reversibly deformable from a relaxed state to a stretched state for storing mechanical energy. The spool is coupled to the elastic rope, and is configured to maintain the elastic rope in the stretched state while the elastic rope is wound around the spool. The control mechanism is coupled to the spool and is configured to allow the spool to rotate in response to the elastic rope returning from the stretched state to the relaxed state for retrieval of stored mechanical energy.

In another embodiment, a device for storing mechanical energy suitably comprises an elastic rope, a first spool, a second spool and a control mechanism. The elastic rope has a first end and a second end, and the rope is reversibly deformable from a relaxed state to a stretched state. The first spool is coupled to the first end of the elastic rope and is configured to maintain a stretched portion of the elastic rope in the stretched state while the stretched portion of the elastic rope is wound around the first spool. The second spool is coupled to the second end of the elastic rope and is configured to maintain the relaxed portion of the elastic rope in the relaxed state while the relaxed portion of the elastic rope is wound around the second spool. The control mechanism is coupled to the spool assembly and is configured to allow the first and second spools to rotate in response to the stretched portion of the elastic rope moving from the stretched state to the relaxed state.

In still other embodiments, a system for transmitting mechanical energy to a load comprises an elastic rope that comprises an elastomeric member wrapped with a strengthening material and that is reversibly deformable from a relaxed state to a stretched state. A spool, reel or other means is provided for receiving and maintaining the elastic rope in the stretched state. A control mechanism or other means for controllably moving the elastic rope from the stretched state to the relaxed state is also provided to thereby allow mechanical energy stored in the elastic rope to be transmitted to the load.

The various implementations may be enhanced or modified in many different ways to create any number of alternate embodiments. In some implementations, for example, the elastic rope may be formed from an elastomer wrapped with a fiber made from carbon nanotubes or other synthetic strengthening materials.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a diagram of an exemplary embodiment of a spring motor device;

FIG. 2 is a diagram of an exemplary elastic rope;

FIG. 3 is a block diagram of an exemplary energy storage system;

FIG. 4 is a diagram of an alternate exemplary embodiment of a spring motor device having two separated spools; and

FIG. 5 is a cross-sectional diagram of an alternate exemplary embodiment of a spring motor device with two concentric spools.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various embodiments provide energy storage devices and/or systems with relatively high energy densities. This density is provided by storing mechanical energy in an elastic rope that can be stretched to store potential energy. The stored energy is then recovered at a later time when the elastic rope is allowed to relax. In various embodiments, the rope can be spooled or otherwise stretched in a manner that provides for a relatively uniform stress throughout the rope, thereby providing greatly improved energy density.

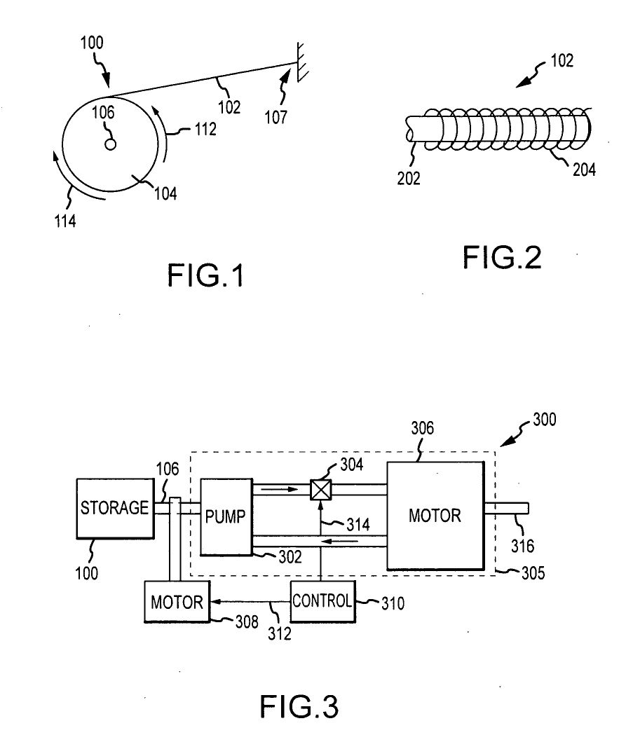

Turning now to the drawing figures and with initial reference to FIG. 1, an exemplary energy storage device 100 suitably includes an elastic rope 102 that stretches and is maintained in its stretched state by a spool 104 as appropriate. In the embodiment illustrated in FIG. 1, elastic rope 102 is rigidly fixed at one end 107 to allow the rope 102 to be stretched as spool 104 rotates in direction 112. As rope 102 relaxes, spool 104 is pulled in the opposite direction 114 by elastic forces in rope 102. This movement in direction 114 may be harnessed, controlled and/or coupled to any sort of load in any appropriate manner. A shaft 106 protruding from spool 104, for example, can be directly or indirectly coupled to any mechanical load for transferring kinetic energy released from rope 102.

Elastic rope 102 is any sort of cord, strand, thread or other line capable of stretching to store potential energy and relaxing to release the stored energy as described herein. In various embodiments, rope 102 includes an elastic member and a strengthening member that may be joined or inter-combined in any manner, as described more fully below. The entire length of elastic rope 102 may be formed of a single strand in some embodiments; alternately, rope 102 may be fashioned from any number of multiple strands or other segments that are spliced or otherwise joined to create a rope 102 of suitable length, elasticity, efficiency, and other parameters.

Spool 104 is any sort of reel, coil, bobbin or other structure capable of applying a tensile stretching force to elastic rope 102 and of maintaining at least a portion of elastic rope 102 in its stretched state until it is desired to release the energy stored in the stretched rope 102. In various embodiments, spool 104 is directly or indirectly coupled to a shaft 106 that rotates and provides torque by relaxing rope 102.

Rotation of spool 104 in either direction 112 or 114 may be controlled in any manner. In various embodiments, a control feature is coupled to shaft 106 or another portion of the spool assembly to apply a stretching torque that results in tensile force being applied to elastic rope 102 and/or to control the resulting torque applied by relaxing rope 102. As tensile force is applied to rope 102 with external mechanical energy (e.g., by turning spool 104 in direction 112), rope 102 stretches along its long axis, and the stretched portion of rope 102 is wound around spool 104, storing the applied mechanical energy.

When rope 102 is allowed to relax, it turns spool 104 in direction 114 providing torque and rotation to shaft 106 in the same direction, thus recovering the stored mechanical energy (minus any losses due to friction). Stored mechanical energy may be retrieved from the stretched portions of rope 102 in any manner. In various embodiments, spool 104 is allowed to controllably rotate in direction 114 when the tensile force on rope 102 is reduced or removed. Tensile force is adjusted or removed by reducing the applied torque on shaft 106 in some embodiments. Tensile force can also be reduced through application of a mechanical, hydraulic or other brake on spool 104, as described more fully below. In the embodiment illustrated in FIG. 1, spool 104 rotates in direction 114 about shaft 106 when the contractile force in rope 102 exceeds the tensile force applied by the spool assembly. This rotation in direction 114 can be coupled (e.g., via shaft 106) to apply a torque that is determined by the design of rope 102.

As noted above, many different types of elastic ropes 102 could be used across a wide variety of alternate embodiments. FIG. 2, for example, shows an elastic rope 102 formed from a relatively cylindrical elastic member 202 that is wrapped with a strengthening member 204 to create an elastic rope 102 that is both strong and that has substantial elasticity for storing a significant amount of potential energy. Elastic member 202 may be formed of any sort of elastomer or elastic polymer, such as any sort of natural or synthetic rubber, synthetic polyisoprene (IR), polybutadiene (BR), thermoplastic, and/or other elastomeric material as desired.

As shown in FIG. 2, a strengthening member 204 can be wound around the elastomeric member 202 to create a rope 102 that can respond to significant tensile force by stretching instead of breaking or permanently deforming. Strengthening member 204 may be formed of any sort of synthetic or other fiber, such as any sort of metallic fibers, glass fibers, ceramic fibers or other synthetic fibers as desired. In various embodiments, elastic rope 102 is strengthened by the use of a member 204 formed from any specialty fiber such as poly-di-imidazo-pyridinylene-phenylene (PIPD) fiber (e.g., the A5® brand fiber available from the DuPont Corporation of Wilmington, Del.) or poly-paraphenylene terephthalamide fiber (PPTA) fiber (e.g., the KEVLAR® brand fiber also available from the DuPont Corporation), or any other synthetic fiber available from any other source. High strength, light weight, high stretch fibers will typically provide the highest energy storage density. In still other embodiments, elastic rope 102 is strengthened by a member 204 that includes any number of (e.g., a million or more) single-walled continuous carbon nanotubes (CNTs) spun or otherwise formed into a fiber.

Elastic rope 102 may therefore be formed from any sort of materials to create a reversibly deformable line that is capable of enough displacement for storing a significant amount of potential energy that can be subsequently retrieved. Energy stored in this elastic rope 102 may be retrieved in any manner, as described more fully below.

With reference now to FIG. 3, an exemplary system 300 for controllably retrieving the stored energy from the elastic rope 102 suitably includes a hydraulic system 305. Hydraulic system 305 suitably includes a positive displacement hydraulic pump 302 that receives a relatively constant torque from the energy storage device 100 via shaft 106 and transmits fluid pressure to a positive displacement hydraulic motor 306 that is capable of driving an output shaft 316 as desired.

In the embodiment shown in FIG. 3, hydraulic system 305 includes a valve 304 that controls the fluid flow between pump 302 and motor 306. By closing valve 304, fluid flow in the hydraulic system 305 is stopped, thereby preventing subsequent movement of shaft 106. Conversely, fluid flow in hydraulic system 305 can be adjusted through control of valve 304 to achieve the desired rotating speed of shaft 106. That is, by opening, closing or otherwise adjusting valve 304, shaft 106 is allowed to move (e.g., in direction 114 described above) in response to contractile forces in the elastic rope 102 as desired. Torque received at hydraulic pump 302 on shaft 106 in this embodiment is therefore translated through hydraulic system 305 to hydraulic motor 306 using conventional hydraulic principles to provide the desired horsepower on output shaft 316.

Although FIG. 3 focuses on hydraulic coupling of shaft 106 to output shaft 316, various equivalent embodiments could provide control such as a mechanical brake that restricts rotation of shaft 106 or a controllable load on shaft 106.

Controller 310 is any sort of mechanical or electronic system that can control the speed and thus the power produced on shaft 106. An electronic control system would be a programmable control module, such as any sort of microcontroller, microprocessor, programmable logic device, or programmable device. In various embodiments, controller 310 is a conventional digital microcontroller with associated memory for storing digital instructions, data and/or other information as appropriate. Such instructions may include any sort of software, firmware or other logic that directs the application of signals 314 to control valve 304 to extract stored energy from device 100 as desired.

In some embodiments, system 300 also provides for a charging motor 308 or other drive feature that applies charging torque to shaft 106 (or another linkage coupled to spool 104) to thereby apply tensile force to elastic rope 102. This stretching torque will also typically wind the elastic rope 102 around spool 104 in any convenient manner. The motor 308 or other drive feature that applies the stretching torque to storage device 100 may be powered from any source, such as an electric motor, steam engine, heat engine, wind turbine, etc. Storage device 100 may therefore be charged from any energy source as desired.

Charging torque may be applied to shaft 106 in response to any sort of control signal 312 generated and applied by any electronic controller 310. Although FIG. 3 shows a single electronic controller 310 as providing both signals 312 and 314, in practice separate control logic or modules could be used for stretching and relaxing elastic rope 102 as desired.

While FIG. 3 shows system 300 as including a charging feature, other embodiments may wind the stretched rope 102 around spool 104 in a different location. That is, it is not necessary that spool 104 be physically present within the system 300 during both stretching and relaxing of rope 102. To the contrary, rope 102 may be wound onto spool 104 in any convenient location, with the wound coil on spool 104 then being transported to a different location for delivery of the stored energy. In transportation applications, for example, rope 102 may be stretched onto spool 104 at any convenient location (e.g., a terrestrial location), and then transported to a less-convenient location (e.g., a vehicle or aircraft) where the energy stored in rope 102 can be released. Not all embodiments, then, will provide for controlled movement of spool 104 in both directions 112 and 114 or for on-site charging of storage device 100.

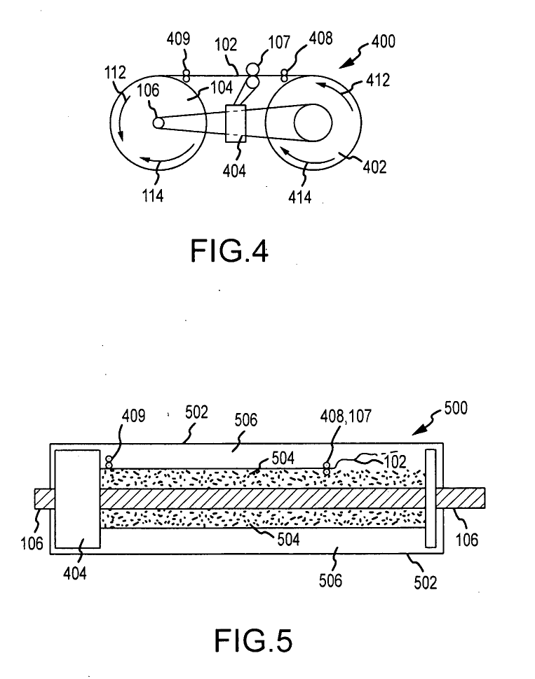

FIGS. 4 and 5 show two examples of energy storage devices 400 and 500 with various additional features. Storage device 400 shown in FIG. 4, for example, contains two separate spools including a “tight” spool 104 and a “loose” spool 402 that are each attached to opposite ends of elastic rope 102. Spool 104 suitably functions as the winding spool described above in conjunction with FIG. 1 in that spool 104 is able to receive and maintain the stretched portion of the elastic rope 102. In various embodiments, spool 104 also serves to apply the tensile force to elastic rope 102 as appropriate. In such embodiments, a shaft 106 is typically coupled to spool 104 to translate input and/or output torque as desired.

Capstan 107 anchors the stretched portion of rope 102, and spool 402 maintains the relaxed portion of rope 102. Capstan 107 could be cogged, or could have a pinch roller. In various embodiments, spools 104, 402, and capstan 107 are inter-linked through a belt drive, chain drive, gear system or other transmission 404, so that the two spools and capstan 107 all rotate at the same time. Transmission 404 may be designed so that the spool 104 and capstan 107 turn at different rates such that full tension is applied to the portion of rope 102 coiled on spool 104. Spool 402 is driven such that its linear rate matches the linear rate of capstan 107, maintaining a slight tension on the relaxed portion of rope 102. Angular rotation rates (and corresponding linear rates of taking up or releasing rope 102) can be adjusted in response to gearing provided in transmission 404, in response to electronic drive controls applied to spools 102, 402, and capstan 107, and/or in any other manner.

The elastic rope 102 may be guided into place in any manner. For the exemplary device 400 shown in FIG. 4, baler 409 travels back and forth laterally across spool 104 to ensure a uniform coil, similar to a conventional fishing reel. Likewise, baler 408 guides rope 102 on and off spool 402 in this embodiment. Each baler's motion may be directly driven by the corresponding spool's rotation, as appropriate.

Further, as the turning radii of the two spools changes during operation, it may be desirable to adjust the relative angular rate of rotation between the two spools to preserve a relatively constant linear rate at which rope 102 is taken up by spool 104. As a larger portion of rope 102 is stretched and received at spool 104, for example, the effective diameter of the spool 104 increases while the effective diameter of the depleted spool 402 is reduced. Hence, it may be desirable to slow the angular rate of rotation of spool 104 relative to capstan 107 as spool 104 becomes increasingly full in order to preserve uniform linear stretching of rope 104. Spool 104, then, may be configured to take up elastic rope 102 at a relatively constant linear rate that remains consistent with respect to the rate at which that the elastic rope is released from the second spool. In an exemplary embodiment in which the elastic rope 102 is capable of stretching to approximately twice its relaxed length, for example, it may be desirable that spool 104 accept stretched rope 102 at a the linear rate that is approximately two times the linear rate that relaxed rope 102 is released from spool 402 to maintain maximum tension on the stretched portion of rope 102. Other rates and relationships between rates may be equivalently applied for ropes 102 that have different capabilities for stretching, as appropriate.

As shown in FIG. 4, storage device 400 appears somewhat similar to a conventional negator spring motor where a conventional clock spring is reverse wound onto a second spool. Unlike a negator spring motor, however, the storage device 400 of FIG. 4 uses tensile force on an elastic rope 102 to store potential energy, thereby allowing significantly more energy to be stored in the equivalent space and mass.

FIG. 5 shows an exemplary energy storage device 500 that is maintained within a can assembly 502 for efficient spatial layout. In this case, spool 104 is located inside spool 402. In the exemplary device 500 shown in FIG. 5, the stretched coil 504 of elastic rope 102 is spooled around shaft 106 at the central portion of the can assembly 502, and the relaxed portion of rope 102 is placed in coil 506, which lies inside the housing of can assembly 502.

In various embodiments, traveling baler 409 would guide stretched rope 102 on and off coil 504, and traveling baler 408 would guide relaxed rope 102 on and off coil 506. Baler 408 would move laterally, circumferentially, and radially, as needed to follow coil 506 and operate in the small space between the coils. Baler 409 would ride parallel to baler 408, and would have independent lateral movement as need to follow coil 504. In this case, capstan 107 must ride on baler 408. In the exemplary embodiment illustrated in FIG. 5, when charging the storage system, relaxed rope 102 in coil 506 passes through capstan 107 riding on baler 408, and is stretched onto coil 504 via baler 409. As shaft 106 rotates in the stretching direction (direction 112 in FIG. 1), rope 102 is stretched and coiled in the central region of the can assembly. When discharging the storage system, shaft 106 is allowed to rotate in the opposing direction (direction 114 in FIG. 1) due to the tension in rope 102. The stretched rope 102 from coil 504 passes through baler 409 and then through capstan 107 which is riding on baler 408. The capstan slightly compresses rope 102 into coil 506 which will then remain in place due to the compression. In various embodiments, variable transmission 404 compensates for changing radius in coil 504 and 506 to maintain relatively constant rates of energy collection and distribution in response to stretching and relaxation of elastic rope 102, as desired.

The various devices and systems above therefore provide for efficient storage of mechanical energy in a manner that provides a very effective energy density.

As used herein, the word “exemplary” means “serving as an example, instance, or illustration”. “Exemplary” embodiments are not intended as models to be literally duplicated, but rather as examples that provide instances of embodiments that may be modified or altered in any way to create other embodiments. Any implementation described herein as “exemplary” is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. Various changes may be made in the function and arrangement of elements described without departing from the scope of the invention and its legal equivalents.

What is claimed is:

1. A device for storing energy, the device comprising:
an elastic rope that is reversibly deformable from a relaxed state to a stretched state;
a spool coupled to the elastic rope, wherein the spool is configured to maintain the elastic rope in the stretched state while the elastic rope is wound around the spool; and
a control mechanism coupled to the spool and configured to allow the spool to rotate in response to the elastic rope relaxing from the stretched state to the relaxed state.

2. The device of claim 1 wherein the elastic rope comprises an elastomer core wound with a strengthening material.

3. The device of claim 2 wherein the strengthening material comprises a synthetic fiber.

4. The device of claim 1 wherein the elastic rope comprises a fiber made from carbon nanotubes.

5. The device of claim 1 wherein the elastic rope comprises poly-di-imidazo-pyridinylene-phenylene (PIPD) fiber.

6. The device of claim 1 further comprising a motor coupled to the spool and configured to drive the spool in a first direction to thereby stretch the elastic rope and to wind the elastic rope about the spool.

7. The device of claim 6 wherein the control mechanism is configured to allow the spool to rotate in a second direction opposite the first direction when the elastic rope relaxes from the stretched state to the relaxed state.

8. The device of claim 1 wherein the control mechanism comprises a hydraulic system configured to regulate rotation of the spool.

9. The device of claim 1 further comprising a shaft coupled to the spool and configured to transmit mechanical energy from rotation of the spool.

10. The device of claim 1 wherein the elastic rope is wound onto the spool external to the device.

11. The device of claim 1 further comprising a second spool coupled to the elastic rope, wherein the second spool is configured to receive the elastic rope in the unstretched state.

12. The device of claim 1 further comprising a can assembly configured to house the spool and the elastic rope such that the elastic rope in the stretched state is wound about the spool in a central portion of the can assembly and such that the elastic rope in the relaxed state is displaced in a space between the spool and the can assembly.

13. The device of claim 12 further comprising a capstan and a pinch roller configured to maintain tension of the elastic rope.

14. A device for storing energy, the device comprising:
an elastic rope that is reversibly deformable from a relaxed state to a stretched state, wherein the elastic rope has a first end and a second end;
a first spool coupled to the first end of the elastic rope, wherein the first spool is configured to maintain a stretched portion of the elastic rope in the stretched state while the stretched portion of the elastic rope is wound around the first spool;
a second spool coupled to the second end of the elastic rope, wherein the second spool is configured to maintain a portion of the elastic rope in the relaxed state while the relaxed portion of the elastic rope is wound around the second spool; and
a control mechanism coupled to at least one of the first and second spools and configured to allow the first and second spools to rotate in response to the stretched portion of the elastic rope relaxing from the stretched state to the relaxed state.

15. The device of claim 14 wherein the elastic rope comprises an elastomer core wound with a strengthening material.

16. The device of claim 14 wherein the elastic rope comprises an elastomer core wound with a fiber made from carbon nanotubes.

17. The device of claim 14 wherein the first and second spools are mechanically coupled to each other to maintain a substantially constant rate of rotation between the first and second spools.

18. The device of claim 17 wherein the first spool is configured to take up the elastic rope at a substantially constant linear rate.

19. A system for transmitting mechanical energy to a load, the system comprising:
an elastic rope that is reversibly deformable from a relaxed state to a stretched state, the elastic rope comprising an elastomeric member wrapped with a strengthening material;
means for receiving and maintaining the elastic rope in the stretched state; and
means for controllably relaxing the elastic rope from the stretched state to the relaxed state to thereby allow mechanical energy stored in the elastic rope to be transmitted to the load.

20. The system of claim 19 wherein the strengthening material is a fiber made from carbon nanotubes.
